(19) United States
(12) Patent Application Publication
(10) Pub. No.: US 2011/0066507 A1
(43) Pub. Date: Mar. 17, 2011

(54) Context Enhanced Marketing of Content and Targeted Advertising to Mobile Device Users

(75) Inventors: Prakash R. Iyer, North Andover, MA (US); Rangamani Sundar, Windham, NH (US); Manish Jha, Wilton, CT (US); Kumar Raman, Haverhill, MA (US); Michael Katzenellenbogen, Brooklyn, NY (US)

(73) Assignee: ENVIO NETWORKS INC., Andover, MA (US)

(21) Appl. No.: 12/880,276

(22) Filed: Sep. 13, 2010

Related U.S. Application Data
(60) Provisional application No. 61/242,007, filed on Sep. 14, 2009.
(60) Provisional application No. 61/265,401, filed on Dec. 1, 2009.

(51) Int. Cl. G06Q 30/00; G06Q 99/00

(52) U.S. Cl. 705/14.66; 705/319

(57) ABSTRACT

A content recommendation and targeted contextual advertising platform is provided that leverages social networking connectivity among users in order to identify content of potential interest of users, and to present recommendation and/or targeted advertisements for such content to users depending on the context of the content.

### RELATED APPLICATIONS

This application claims priority to U.S. Provisional Application No. 61/242,007, filed Sep. 14, 2009 and to U.S. Provisional Application No. 61/265,401, filed Dec. 1, 2009. The entirety of each of these applications is incorporated herein by reference.

### TECHNICAL FIELD

The present disclosure relates to marketing content and displaying contextually relevant advertisements to users by leveraging relationships between users in on-line social networks.

### BACKGROUND

The distribution of content to users in online environments has exploded in recent years. Examples of such content include applications for user computing devices (desktop or laptop computers as well as smartphone devices), music, videos and games. However, due to the abundance of available content, it has become overwhelming to users to sort through content according to their interests. Online cataloging of content is generally cumbersome for a user to navigate in order to identify content that matches a user's interests.

The same applies to dissemination of information in general. There is so much information available to people for numerous applications. The challenge is finding the best or most appropriate information for a particular topic for a given user.

### SUMMARY

A content recommendation and contextual advertising platform is provided that leverages social networking connectivity among users in order to identify content of potential interest of users, and to present recommendation and/or relevant advertisements for such content to users depending on the context of the content.

A context based trust inference value is computed between users depending on the type or nature of the content. In this way, the content recommendation and contextual advertising platform models how a person may manage the expertise of knowledge of his/her friends depending on the context of the topic.

### BRIEF DESCRIPTION OF THE DRAWINGS

FIG. 1 is a block diagram illustrating a system for social network context based marketing of content to users.

FIG. 2 is an example of a block diagram illustrating interaction between a context based content server and a client device interface application that resides in a user access point device.

FIG. 3 is an example of a flow chart depicting basic operations of the context based content server.

FIG. 4 is an example of a diagram depicting connected users and how a trust inference value between users is computed from participation data.

FIG. 5 is an example of a diagram depicting connected users and how a context-specific trust inference value is computed and an overall trust inference value is computed between connected users.

FIG. 6 is an example of a diagram depicting examples of contexts for which context-specific trust numbers are computed between connected users.

FIG. 7 is an example of a diagram depicting examples of a hierarchical arrangement of contexts for which context-specific trust numbers are computed between connected users.

FIG. 8 is an example of a flow chart depicting a process for computing context-specific trust inference values for connected users according to the concepts presented in FIGS. 5-7.

FIG. 9 is an example of a diagram depicting a plurality of demographic and psychographic groups to which users may belong, and from which trust-inference values between connected users may be adjusted.

FIG. 10 is an example of a diagram depicting computation of a context-specific trust inference value between a pair of users depending on groups or clusters to which the users in the pair belong.

FIG. 11 is an example of a flow chart depicting a process to adjust trust inference values between connected users according to the groups or clusters to which the users belong.

FIG. 12 is an example of a diagram depicting connected users and a technique for minimizing the computations necessary for computing trust inference values between connected users.

FIG. 13 illustrates an example of a flow chart for a depth limiting process with respect to the computations performed between connected users according to the concepts presented in FIG. 12.

FIG. 14 is an example block diagram of a server configured to perform the processes described herein.

FIGS. 15A-15G are screen shots showing examples of user interface screens presented on a user access point device to show how a user accesses data generated and provided by the context based content server.

FIGS. 16 and 17 are screen shots showing examples of user interface screens through which a user sets his/her preferences or user profile information.

FIG. 18 is an example of a flow chart depicting operations of the context based content server invoked when a user newly registers for service with the context based content recommendation server.

FIG. 19 is a screen shot showing an example of a user interface screen presented to a user during execution of the process shown in FIG. 18.

FIG. 20 is an example of a flow chart depicting functions of the context based content server to gather data pertaining to reviews of content from expert mavens and from other sources to generate virtual digital personas, which are later used to create personalized recommendations and contextual advertisements.

### DETAILED DESCRIPTION

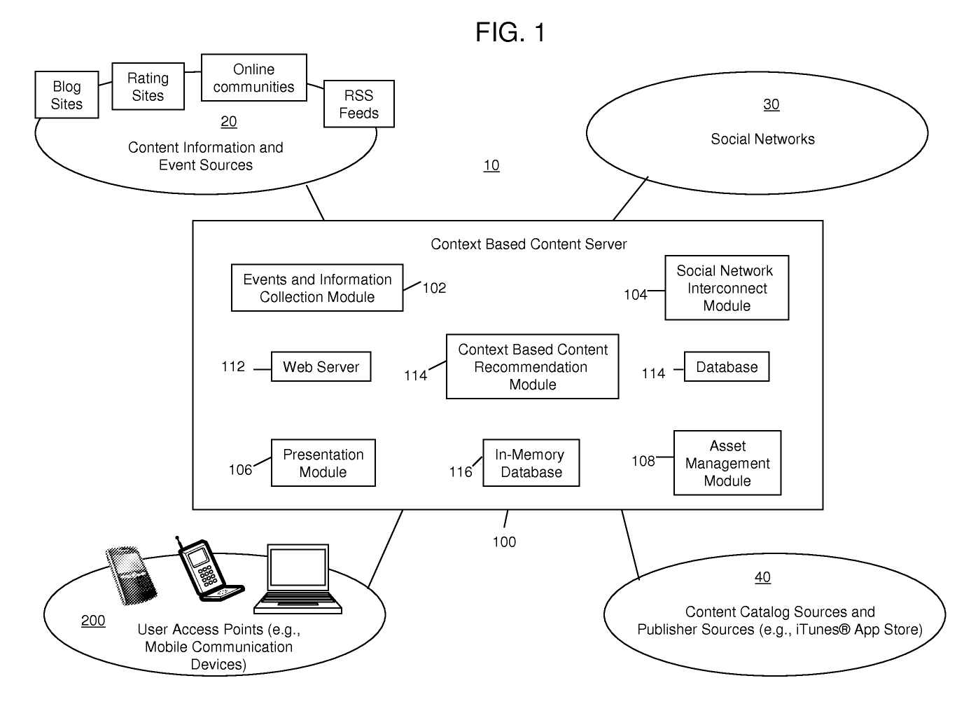

Referring first to FIG. 1, a system is shown at reference numeral 10 for marketing of content, such as software applications, digital media content (music, videos, games) and other information, goods or services to users. The system 10 comprises a context based content server 100 that is configured to generate recommendations for relevant content that may be of interest to a user. For example, the content may be applications that run on a user computing device, such as a desktop or laptop computer, or a hand-held device such as a smartphone device, e.g., an iPhone™ or Blackberry™ device, or a web page the user visits. The user computing devices or web pages referred to above are only examples and are not meant to be limiting.

In the system 10, the user computing devices are also referred to as user access point devices and are shown at reference numeral 200. Users may register for service with the context based content server 100 to receive recommendations for content based on context specific trust inferences computed by the context based content server based information derived for a user's “contextual circle” comprises connected users as described in detail hereinafter.

The context based content server 100 comprises several software modules including an events and information collection module 102, a social network interconnect module 104, a presentation module 106, an asset management module 108 and a context based content recommendation module 110. To assist in its functions, the context based content server 100 may also comprise a web server 112, a database 114 (such as a SQL database) and an in-memory database 116.

The events and information collection module 102 communicates with and retrieves from (via the Internet, for example) various content information and event sources shown collectively at reference numeral 20, such as blog sites, content rating sites, online communities and RSS feeds. The social network interconnect module 104 communicates with and retrieves data pertaining to activity of users from various online social networks shown collectively at reference numeral 30, such as Facebook™, Myspace™, Twitter™, Orkut™, Bebo™, etc. The presentation module 106 generates and supplies to user access point devices 200 presentation data pertaining to content recommendation and other information for users that have registered for service with the context based content server 100. The asset management module 108 communicates and retrieves from content from content catalog sources and publisher sources shown at reference numeral 40, such as, for example, the iTunes® applications (App) store. The term “participation data” is used herein to refer to data associated with a user's interaction with other users, a user's web browsing activity, a user's interaction with content information and event sources 20 and with content catalog and publisher sources 40.

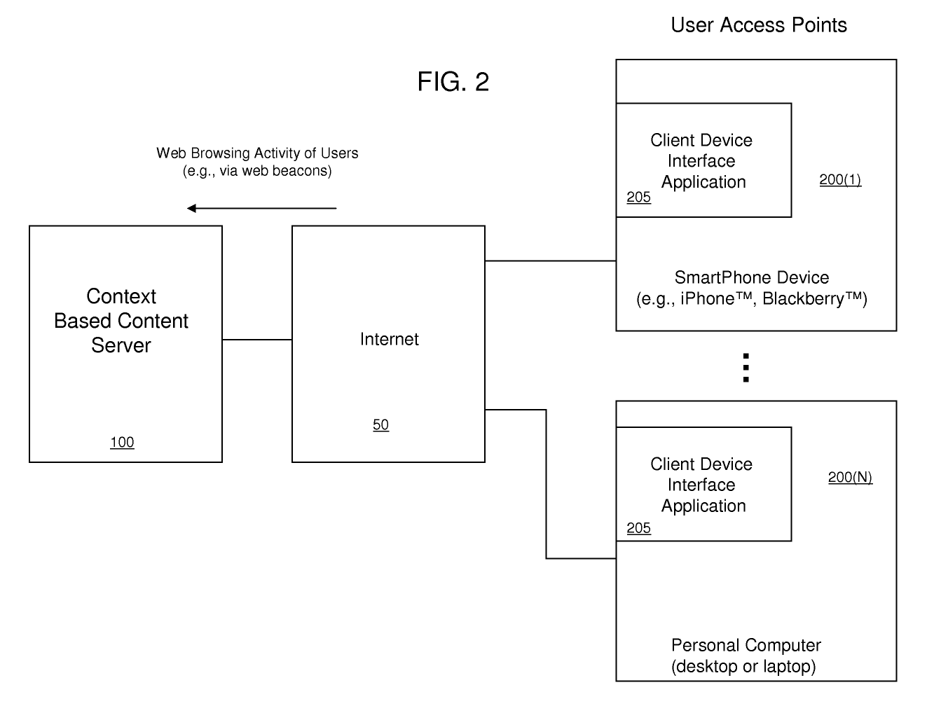

Turning to FIG. 2, a block diagram is shown whereby the context based content server 100 communicates with user access points 200(1)-200(N) by way of the Internet shown at reference numeral 50. In one embodiment of the system 10, each user access point includes a client device interface application 205 that communicates with modules of the context content server 100. The client device interface application 205 is, for example, a small plug-in application that enables the user access point to communicate with the context based content server 100 to supply settings and other commands entered by a user and to receive presentation data to a user.

In another form, and as shown in FIG. 2, when a client device interface application is not available (or event if it is available), web-beacons may be used to track user's web browsing activity and use that information as input to the context based content recommendation module 110. A web beacon is an object that is embedded in a web page or e-mail and is usually invisible to the user. The web beacon allows verification of whether a user has viewed a web page (or read an email). A web beacon is a small (usually 1×1 pixels) transparent image (or an image of the same color of the background) that is embedded in an HTML page. When a user opens the page with a browser from his/her mobile device, the image is downloaded. This download requires the browser to request the image to the server storing it, allowing the server to take notice of the download. As a result, the organization running the server is informed of when the HTML page has been viewed. When a web page (with or without beacons) is downloaded, the server holding the page knows and can store the IP address of the device requesting the page. This information can therefore be retrieved from the server log files without the need of using beacons. Web beacons are used when monitoring is done by a server that is different than the one holding/serving the web pages, for example, when the web pages are served by different servers, or when the monitoring is done by a third party.

It should be understood that there may be other communication networks between each user access point and the server, such as local area networks (wired and wireless) and wide area networks (wired and wireless) such as cellular wide area wireless communication networks that enable two way voice and data communication for user smartphone user access point devices. For simplicity, these other communication networks are not shown in FIG. 2.

In still another embodiment, each user access point device may not need a client device interface application, but rather the functions are directly served to a user access point device by the server 100. An example of this is accessing the service using a web browser or using a text based interface such as short message service (SMS) or unstructured supplementary service data (USSD) from a device. The interface could also be made accessible by other means, such as through a voice interface.

The aforementioned modules of the context based content server 100 are configured to provide recommendations for content to users based on a trust interference model whereby for each user, relationships are tracked with respect to other users and content experts that are part of that user's contextual circle. A social network may be created by the context based content server 100 in order to allow users to connect to other users of the service provider by the server 100. In addition, users of this social network may also pull in their connections to users in other social networks such as Facebook™, MySpace™, etc. A user may therefore be connected to other users for a variety of different reasons. The connection between a given pair of users is tracked to determine recommendations of content to a user.

The weight or distance value given to a relationship between a given user and other users or content experts is dependent on the particular context of the content. For example, certain “friends” of a user may be more reliable with respect to musical interests or food interests, while other friends may be more reliable for interests in utility software applications used on a user access point. The context based content recommendation module computes the relationship weighting or so-called context based “trust inference” for a given user based on activity it learns from that user's contextual circle and provides recommendations for digital content to the user, such as recommendations for software applications, music, web browsing history, etc. These recommendations are quite valuable to the user because he/she knows, based on the context of the content and the particular “friend” or expert, that he/she may share common interests and thus may want to receive information about digital content, targeted contextual advertisements or other related activities of that particular friend or expert.

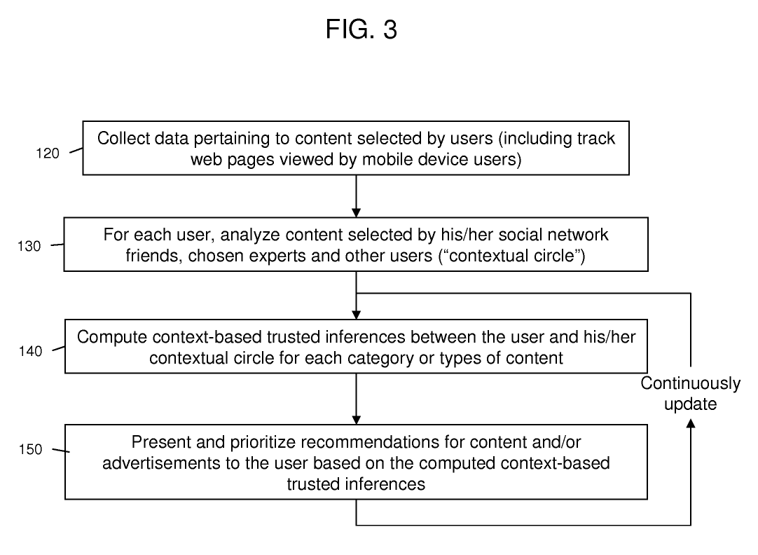

Turning now to FIG. 3, a flow chart is shown that represents basic operations of the context based content server 100. At 120, through the asset management module 108 and social network interconnect module 104, the server 100 collects data pertaining to content purchased, downloaded or otherwise selected by users that are registered for service with the server 100. In addition, at 120, through the events and information collection module 102, the server 100 collects data pertaining to known experts regarding certain digital content, ratings of content, etc., as well information related to web pages viewed by mobile device users. Through the collection of data, the server 100 can monitor activity of users in connection with digital content and interactions between users.

At 130, for each user that has registered for service, the context based content recommendation module 110 analyzes content selected by a users social network friends, chosen experts and other users (referred to above as a user's contextual circle).

At 140, the context based content recommendation module 110 computes context-based trust inferences between connected users, that is between any given user and his/her contextual circle for each category or types of content. For example, the module 110 employs a contextual trust-inference technique that models the social network as a graph. For each user, the module 110 builds a set of friends who have a similar profile wherein a trust-inference value represents the similarity measure or weight. The trust inference values may be modified when a path between nodes (two users) transcends demographic/psychographic boundaries. The server 100 continuously tracks each user's behavior and activity patterns to learn about the user's likes and dislikes for content, who their close friends are for different categories of content, etc.

At 150, through the module 106, the identifiers of content popular among that user's contextual circle are prioritized and presented as recommendations or targeted advertisements to the mobile device user based on the context based trusted interferences computed at 140. In other words, at 150, the server generates recommendations for digital content and information for a particular user for a particular context based on a corresponding context-specific trust inference computed for the particular user with respect to one or more other users that are connected to the particular user. The recommendations may involve targeted context-specific advertisements related to the particular context for display to the particular user.

One example of a technique to compute the context based trust inferences is to use clustering techniques. Based on an assortment of data the server 100 creates user groups/clusters. Each cluster comprises users of similar profiles. A new user, based on the similarity in profile, is slotted to one of the clusters. Content recommendation is based on what is popular within his/her cluster. The clusters are rebuilt at regular intervals to factor in new data gathered. A user's profile also is dynamic and the server 100 periodically re-computes the cluster to which the user belongs based on any changes made to the user's profile.

One advantage of these techniques is that users are presented with recommendations for content by others that they known and can rely on, and without having to browse through catalogs (online or otherwise) of available content, which can be very time-consuming.

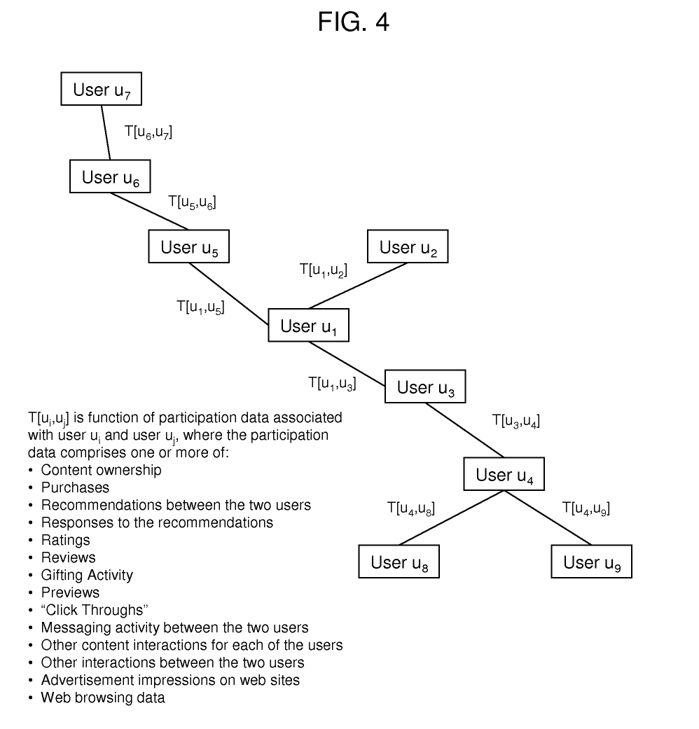

Reference is now made to FIG. 4. FIG. 4 shows a plurality of users u₁-u₉ that have a connection relationship shown in the diagram. For example, user u₁ has a direct connection to user u₂, u₃, and u₅. User u₃ is directly connected to user u₁ and u₄. User u₄ is directly connected to users u₈ and u₉. User u₅ is directly connected to user u₆ and user u₆ is directly connected to user u₇. However, user u₁ has an indirect connection with users u₄, u₆, u₇ and so on. That is, users may have direct connections to each other because these users choose to become connected (friends) to each other, and users may have indirect connections to other users through their direct connections.

The connection between any given pair of connected users uᵢ and uⱼ is represented by a trust inference value or number T[uᵢ,uⱼ]. Users may be viewed as nodes in a network and the connection strength between nodes is represented by the trust inference number T[uᵢ,uⱼ]. The server 100 computes the trust inference value T[uᵢ,uⱼ] based on participation data of users. As indicated in FIG. 4, the participation data comprises one or more of:

Content ownership: The types of music, applications, videos, games, information, etc., that a user owns or has subscribed to, as well as web browsing history data of a user.

Purchases: The types of content that a user has purchased the rights to and other non-content types of purchases, such as clothing, sports equipment, etc.

Recommendations between the two users: The recommendations that the server 100 makes to users or the recommendations that one user sends to another user.

Responses to the recommendations: The responses or actions taken by a user in response to a recommendation.

Ratings: A rating given by a user on content (e.g., 1 star, 2 stars, . . . , 5 stars).

Reviews: A textual review given by a user on content.

Gifting Activity: The gifting of content or other items from one user to another.

Previews: The viewing and/or participation in previews of content by a user.

“Click Throughs”: The click-through behavior of a user in certain presentation/content environments.

Messaging activity between the two users: The exchange of messages between users.

Other content interactions for each of the users: A user's interaction with any other content not listed above.

Other interactions between the two users: Any other interactions between users not listed above.

Advertisements impressions on web sites: Data indicating which advertisements a user selects/views on various web pages.

Web browsing data: Data that tracks mobile device viewing of web pages by mobile device users, using web beacons as described herein or other similar techniques. This allows the server 100 to track data representing web pages viewed by mobile communication device users.

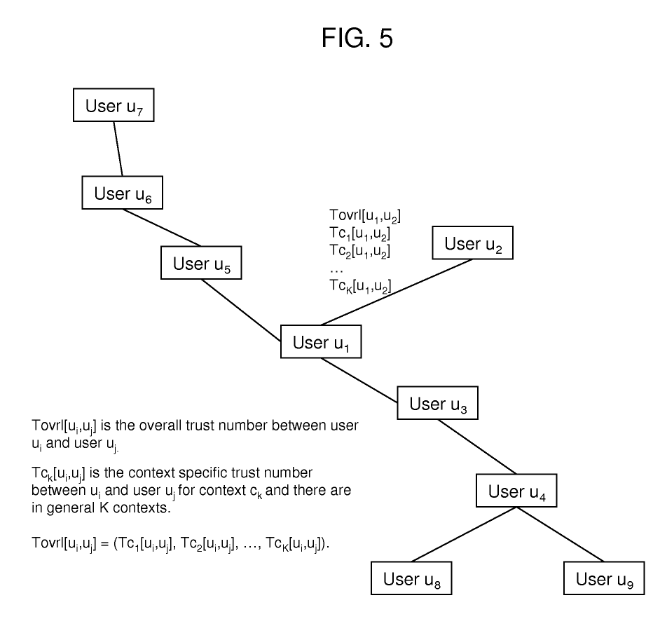

Reference is now made to FIG. 5 for explanation of another aspect of the functions of the server 100. The weight or distance value given to a connection between two users is dependent on a particular context. For example, certain connected users, so-called “friends” of a user, may be more reliable with respect to musical interests or food interests, while other friends may be more reliable for interests in utility software applications used on a user access point. The context based content recommendation module of the server 100 computes the trust inference with respect to another connected user based on activity it learns from that user's connected friends and provides recommendations for digital content to the user, such as recommendations for software applications, music, advertisements, etc. These recommendations are quite valuable to the user because he/she knows, based on the context of the content and the particular friend, that he/she may share common interests and thus may want to receive information about digital content or other related activities of that particular friend or expert.

In FIG. 5, the trust inference number T[uᵢ,uⱼ] between two users is further explained. Between any two users uᵢ and uⱼ, there is an overall trust inference number Tovrl[uᵢ,uⱼ] that is composed of one or more context-specific trust inference numbers denoted Tcₖ[uᵢ,uⱼ], for k=1 to K different contexts. For example, between users u₁ and u₂ there are context-specific trust inference numbers Tc₁[u₁,u₂], Tc₂[u₁,u₂], Tc₃[u₁,u₂], . . . , Tc_{K}[u₁,u₂] and the overall trust inference number between users u₁ and u₂ is Tovrl[u₁,u₂]. The overall trust inference number Tovrl[u₁,u₂] is a vector comprising the individual context-specific trust numbers between u₁ and u₂, that is, Tovrl[u₁,u₂]=(Tc₁[u₁,u₂], Tc₂[u₁,u₂], Tc₃[u₁,u₂], . . . , Tc_{K}[u₁,u₂]).

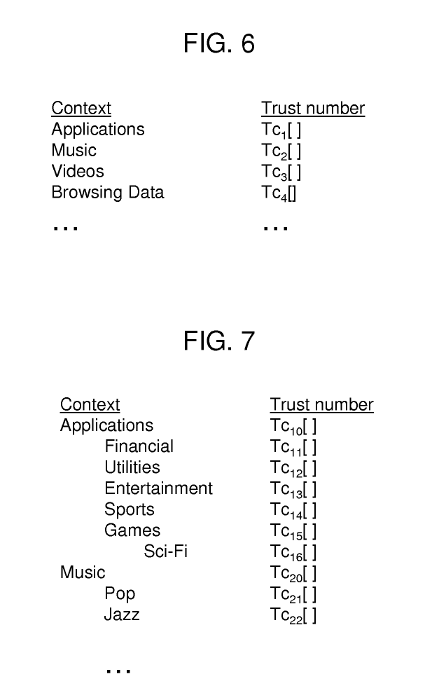

Thus, for each pair of connected users, there is an overall trust inference number Tovrl and one or more context-specific trust inference numbers Tcₖ[uᵢ,uⱼ], for k=1 to K. The contexts may be any grouping of content type. For example, as shown in FIG. 6, there are different trust numbers for the contexts of applications, music, videos, web browsing, etc. Examples of other contexts are games, sports news, politics news, health news and information, etc. Thus, the trust number for one context, e.g., sports, between two uses may be stronger than the trust context for another context, e.g., web browsing, because the two users have a stronger commonality with respect to sports than they do with respect to general web browsing.

Moreover, as shown in FIG. 7, contexts may be arranged in a hierarchical fashion with sub-contexts. For example, there is a broad category or context for applications, and then there are sub-contexts under applications for types of applications, such as financial applications, utilities applications, entertainment applications, sports applications, games applications, etc. There may be further sub-contexts such as “sci-fi” for games applications. Each of these sub-contexts is allocated a trust inference number between two users. When two users have no connection for a particular context, then that trust number is set to a null value, such as zero. As explained above, the overall trust interference number between two users is a vector-valued variable indexed by context. The appropriate component of this vector is used depending on the context being evaluated at that time for purposes of content or information recommendations, etc.

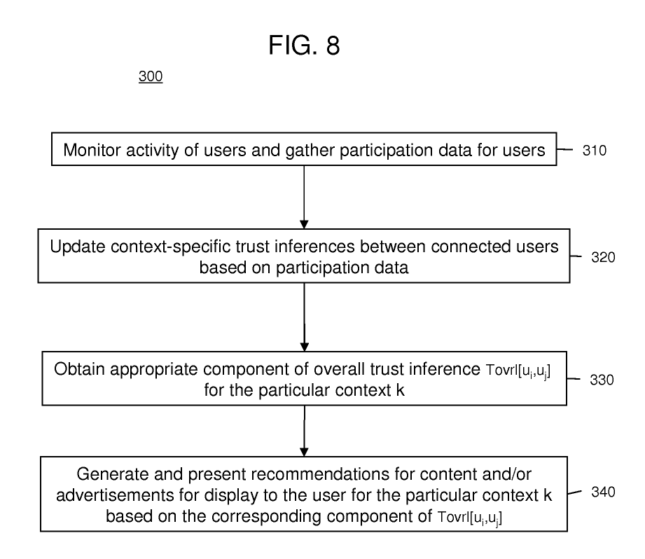

Reference is now made to FIG. 8 for a description of a process 300 performed by the server 100 through operations of the various modules shown in FIG. 1, and depicting a more specific flow of the operations performed in connection with the trust-inferences concepts depicted in FIGS. 4-7. At 310, the server 100 monitors activity of users and gathers participation data for the users. Examples of participation data are described above. At 320, the server 100 computes updates to the context-specific trust inference numbers between connected users based on the participation data.

At 330, the server 100 obtains an appropriate context-specific trust inference number (i.e., an appropriate component of the overall trust inference vector Tovrl[uᵢ,uⱼ] between two users for particular context k). At 340, the server 100 generates and presents recommendations for content and advertisements (i.e., targeted advertisements) to a user (one of the users uᵢ and uⱼ) for the particular context k based on the corresponding component of the overall trust inference vector Tovrl[uᵢ,uⱼ] and based on participation data associated with connected users that is relevant to the particular context k. For example, users uᵢ and uₘ already have a relatively large trust number as between them, and users uₘ and uⱼ have had a significant social interaction (e.g., acceptance of recommendations between each other) in the recent past. In the trust-inference computation between users uᵢ and uⱼ, the trust number between uᵢ and uⱼ will exceed a certain threshold, which in turn will trigger a content recommendation or targeted advertisement in the appropriate context.

Once the context specific trust number between two users exceeds a threshold value, a trigger is generated to make recommendation for content or a targeted advertisement to one or both users. This threshold can be dependent on the context: e.g., work-related applications can require a lesser threshold between middle-management professionals, as compared to the threshold for another context, such as music.

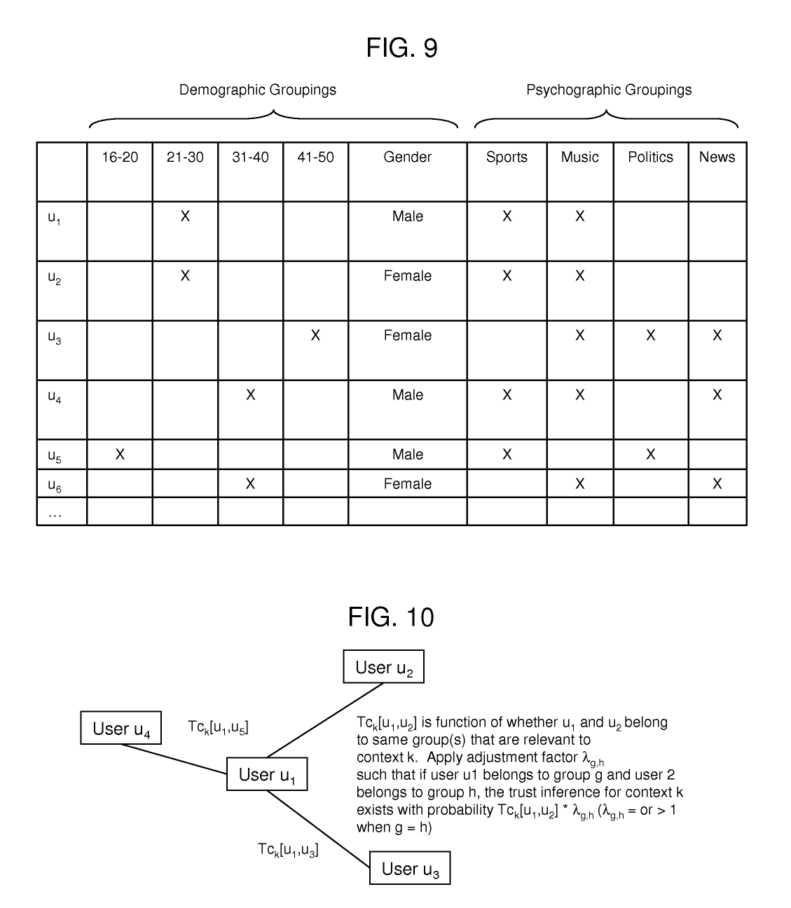

Reference is now made to FIGS. 9 and 10. FIG. 9 illustrates a plurality of groupings or clusters. Some of the groups are based on demographics, such as age and gender, and other groups are based on psychographics, i.e., interests, such as music, politics, sports, etc. For example, demographic groups are broken up into age groups 16-20, 21-30, 31-40, 41-50 and gender (and there may be others as well that are not shown for simplicity). Examples of psychographic groups are sports, music, politics and news and others may be provided as well but only four are shown for simplicity. The server may expressly learn about users to identify their appropriate demographic group and psychographic group through direct prompts to users, or implicitly by observing participation data for that user.

FIG. 10 shows that the context-specific trust inference numbers between two users can be adjusted to account for the groups or clusters to which the two users belong. In other words, the context specific trust inference Tcₖ[uᵢ,uⱼ] is a function of whether users uᵢ and uⱼ belong to the same group or groups that are relevant to context k. A cross-group adjustment factor λ_{g,h} is applied to the context specific trust inference number such that if user uᵢ belongs to group g and user uⱼ belongs to group h, the trust inference for context k (for which groups g and h are relevant) exists with probability Tcₖ[uᵢ,uⱼ]*λ_{g,h}, where λ_{g,h} is greater than or equal to 1 when g=h, and is otherwise less than 1. Thus, the group or groups to which users belong are used to adjust a context specific trust inference depends on the particular context.

Again, the particular group or groups that are used to generate the adjustment factor needs to be relevant to the context specific trust inference. When two users belong to the same group or groups that is relevant to a context, then the adjustment factor may be computed to reinforce or bolster the trust context specific trust inference number between them since recommendations and other common interests for that context would carry more weight. For example, demographic groups are often seen as relevant to tastes in music. Therefore, connected users that are in the same demographic groups should have a trust inference number for music that is boosted, whereas connected users in completely different demographic groups should have a trust inference number for music that is attenuated significantly. In another example, when two users belong to the same group or cluster “West Coast professionals in their twenties”, the context specific trust inference numbers for certain contexts consistent with that grouping should be emphasized, even boosted. Whereas when two users belong to distinct groups or clusters, their interaction may viewed as more “accidental” and the context specific trust inference for those users should be attenuated accordingly.

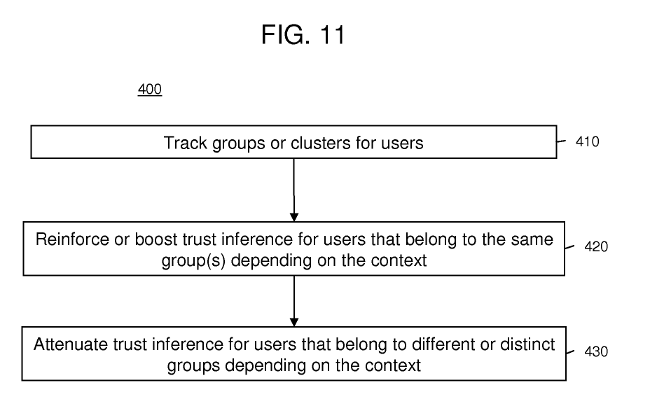

Turning now to FIG. 11, a flow chart is shown for a process 400 performed by the server 100 to implement the group or cluster based adjustment of the trust inference between two users. At 410, the server tracks groups or clusters for users based on direct responses to questions or from observing behavior of users based on their participation data. Depending on the context, the group or clusters of two connected users may be reinforced or boosted when those users belong to the group(s) or cluster(s) as shown at 420. Conversely, the trust inference for users is attenuated for users that belong to different or distinct group(s) depending on the context as shown at 430.

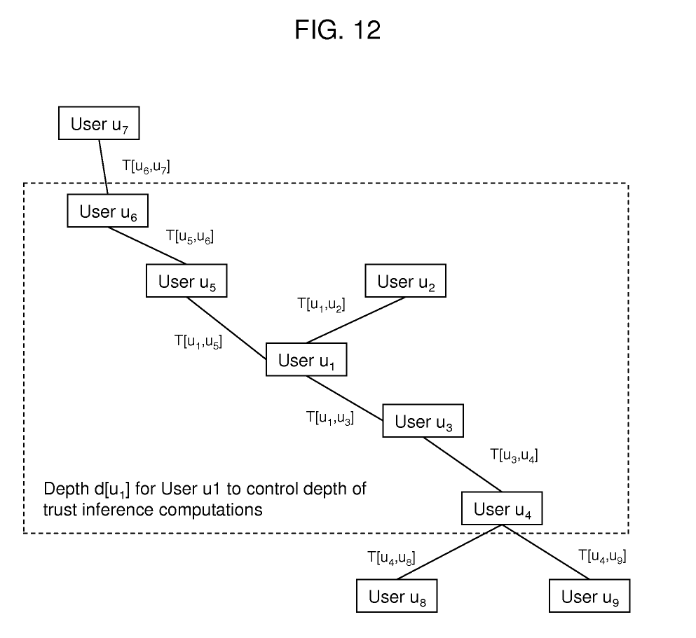

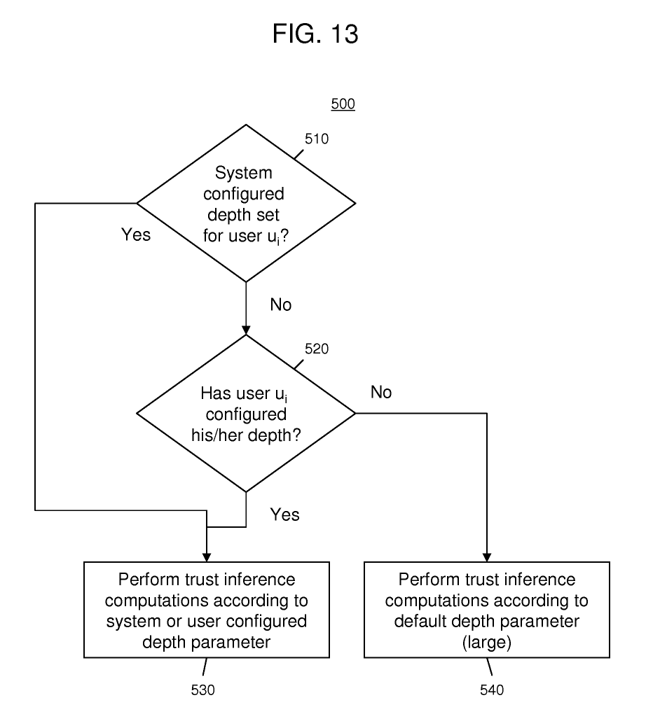

Reference is now made to FIGS. 12 and 13. FIG. 12 shows a connection diagram similar to FIG. 4. For simplicity, the trust inference numbers between users uᵢ and uⱼ is indicated as T[uᵢ,uⱼ] in FIG. 4 without reference to a specific context. In order to allow for faster computations of trust inferences between users, a degree of separation depth or limit is configured, by the system or by a user, to control the number of degrees away from a given user that should be considered in computing trust inferences between any two users. This depth or limit is indicated by d[uᵢ] for user The depth d[uᵢ] is a small integer, for example. In other words, a user uᵢ is considered connected to a user uⱼ only if user uⱼ is at a distance d[uᵢ] from user uᵢ for purposes of computing a trust inference between users uᵢ and uⱼ.

FIG. 12 shows an example where, for user u₁, the depth d[u₁] is configured to be 2. This would then exclude any activity or impact of users u₇, u₈ and u₉ as to the trust inference computations for user u₁.

FIG. 13 illustrates a flow chart for a process 500 executed by the server 100 when optimizing the trust inference computations for user connectivity depth as depicted in FIG. 12. At 510, the server may configure the connectivity depth to be used for all users or a given user. For example, the server may configure the connectivity depth to be relatively small for users that are connected to numerous other users, but may leave the connectivity depth at a relatively large default value for numbers that are connected to a lesser number of other users. When the server has not configured the depth for a user, then at 520 it determines whether a user has configured his/her connectivity depth. A user may decide to configure his/her connectivity depth for a variety of reasons, such as to control the relevancy of recommendations that are provided to him/her by the server. At 530, the server performs the trust inference computations for the user based on the server configured or user configured connectivity depth value. The logic of process 500 may be configured to always use the server configured depth value (over the user configured depth value). At 540, when there is neither the user nor the server has configured a depth connectivity value for a user, the user performs trust inference computations using a default (e.g., relatively large) depth connectivity value.

Turning now to FIG. 14, a block diagram is shown as an example of a data processing platform for the server 100. The server 100 may comprise one or more data processors (e.g., computers) 160 that executes computer software instructions stored or encoded in a tangible (non-transitory) computer readable memory 170. Reference numeral 180 is meant to represent the server software modules referred to above in FIG. 1 and the processes 300, 400 500, 600 and 700 described herein, as well as the process depicted in FIG. 3. The server 100 communicates over various networks using a network interface device 190 in order to collect data from the various data sources shown in FIG. 1, and to communicate information to user access points.

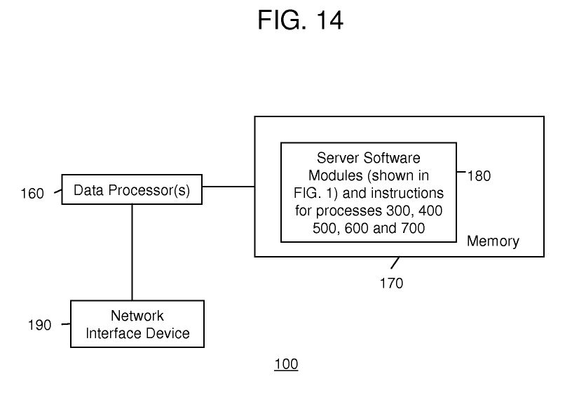

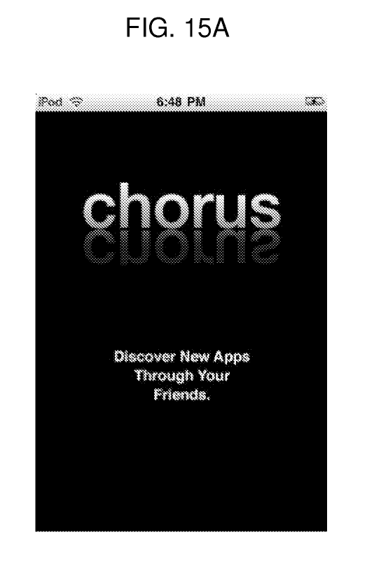

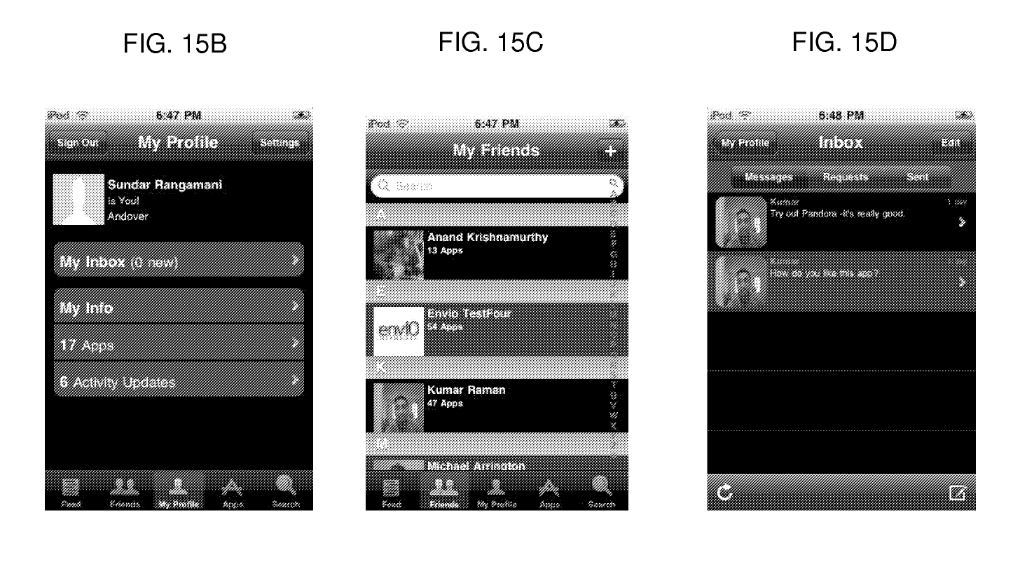

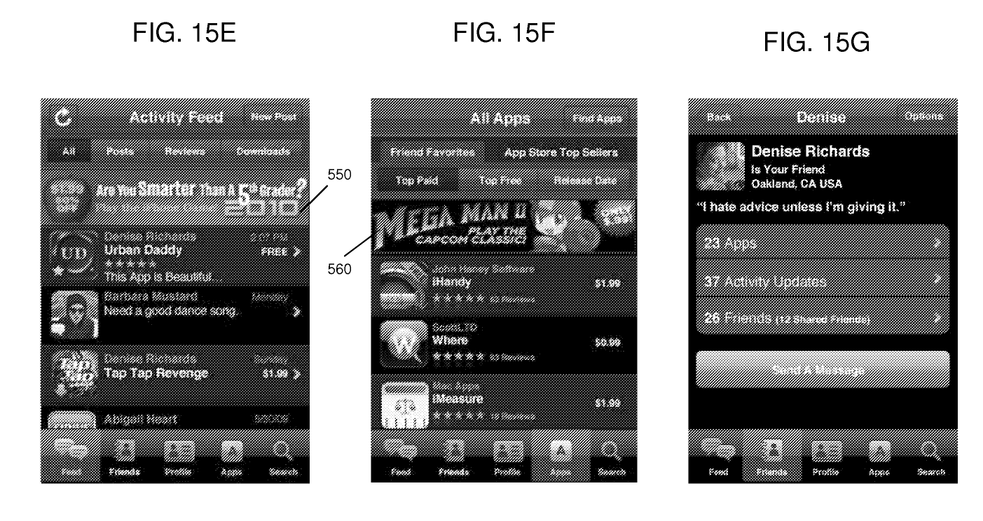

Reference is now made to FIGS. 15A-15G that show examples of user interface screens presented to a user on a user access point device, e.g., a Smartphone device. These figures are example screen shots taken from an iPhone® application that is a client device interface application (of the nature referred to above in connection with FIG. 2). In these figures, the brand name for the service and also the application that resides on an iPhone device is “Chorus”. FIG. 15A illustrates an example of an initial start-up or splash screen that is presented when a user clicks an application icon having the label “Chorus”.

FIG. 15B illustrates an example of the main or My Profile screen user interface screen presented to a user. This screen illustrates an avatar or actual photo a user at the top of the screen and also includes links for My Inbox, My Info, recommended applications (in this example there are 17 recommended applications so “17 Apps” is displayed) and activity updates (in this example there are 6 activity updates so “6 Activity Updates” is displayed). Settings for a user's profile may be adjusted when a settings screen is presented in response to user selection of the “Settings” button in the upper right-hand corner of the screen shown in FIG. 15B. Examples of the settings screen are described hereinafter in connection with FIGS. 5 and 6. There are also buttons at the button of the screen in FIG. 15B, labeled “Feed”, “Friends”, “My Profile”, “Apps” and “Search”.

FIG. 15C illustrates an example of a My Friends screen that is displayed when a user selects the “My Friends” button at the bottom of the My Profile screen shown in FIG. 15B. The My Friends screen lists friends of a user, in this example, in alphabetical order, and an indication as to the number of applications selected by each friend.

FIG. 15D illustrates an example of an Inbox screen that is displayed when a user selects the “My Inbox” button at the bottom of the My Profile screen in FIG. 15B. In the example in FIG. 15D, incoming messages from friends of a user are listed/displayed and more details for a message may be presented when displayed message is selected, also enabling a user to enter a response to the message.

FIG. 15E illustrates an example of an Activity Feed screen that is displayed when a user selects the “Feed” button at the bottom of the My Profile screen in FIG. 15B. The Activity Feed screen presents a list (including corresponding identifying icon) of content that the server has determined was recently selected (downloaded or purchased) by friends of the user. For example, in the example shown in FIG. 15E, the friend whose name is “Abigail Hart” has selected the application iToss and the icon shown to the left is the icon (logo) associated with the iToss application Likewise, the friend whose name is “Denise Richards” is listed second and has recently selected the application Urban Daddy. At the top of the screen shot shown in FIG. 15E, there are buttons labeled All, Posts, Reviews and Downloads. The screen shown in FIG. 15E is the one displayed when the “All” button is selected. Here all activities linked to this user from his circle are displayed. Choosing another option, Posts, Reviews or Downloads, filters the activities that the user will see. In other words, selecting Downloads will show all download (of applications) activities within this user's circle. The specific options are examples and not intended to be exhaustive or otherwise limiting.

In addition, FIG. 15E shows an example of a targeted advertisement displayed to the user at reference numeral 550. The advertisement is for a particular iPhone game “Are You Smarter Than a 5^{Th} Grader” and it is selected for display to the user based on the aforementioned context based analysis performed by the context based content server 100.

FIG. 15F illustrates the Applications screen that is displayed when a user selects the “Apps” button shown at the bottom of FIG. 15B. The Applications screen lists that have been selected by friends of a user. For example, when the “Friends Favorite” button at the top of the screen is selected, the list of applications are sorted by “favorite” applications of the user's friends. In the example shown in FIG. 15F, the application displayed at the top of the list is “TextPlus” selected by the user's friend whose name is John Soft. The list of applications displayed in the Applications screen may be based on other criteria as indicated by the buttons labeled “App Store Top Sellers”, “Top Paid”, “Top Free” and “Release Date”.

Also shown in FIG. 15F is a targeted advertisement shown at reference numeral 560. The advertisement 560 is for an on-line mobile game that is selected by the context based content server 100 using the foregoing context based analysis.

The advertisements shown at 550 and 560 in FIGS. 15D and 15E are examples of targeted contextual based advertisements that are selected for display to a user based on the trust-based inferences concepts described herein. That is, the context based content server 100 first uses the trust inference algorithm and then uses the clustering algorithm (both of which are described above) to generate relevancy, content recommendations and targeted advertisements that are presented to users on their mobile communication devices.

FIG. 15G illustrates the screen that is displayed when a particular friend, Denise Richards, is selected from one of the other screens, such as the Activity Feed screen shown in FIG. 15E. This screen provides some basic profile information for this friend, as well as an indication of the number of recently selected applications (“23 Apps”), other activity updates (“37 Activity Updates”) and this user's friends (“26 Friends”). By selecting the link to Denise Richard's recently selected applications, the user can see a listing of those applications, and likewise for activity updates.

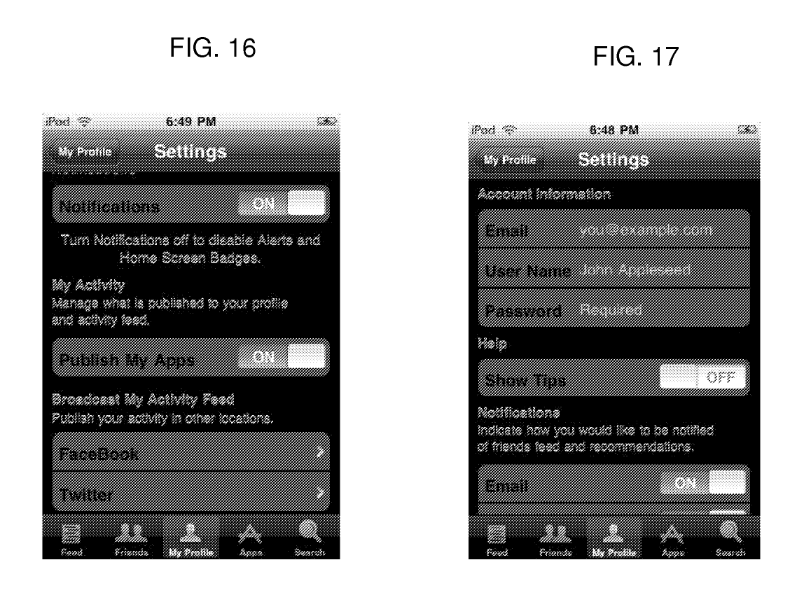

Turning now to FIGS. 16 and 17, settings screens are shown as an example of user interface screens that allow a user to make changes to their profile settings. FIG. 16 illustrates a screen whereby a user can control alerts that are presented to him/her based on activities in his/her contextual circle. In addition, this screen allows a user to make changes to settings that control when information is published to other users in his/her contextual circle based on this user's activities (selecting new content, etc.). FIG. 17 illustrates an example of a basic profile screen through which a user makes changes to basic user profile information such as email, user name, password entry, etc.

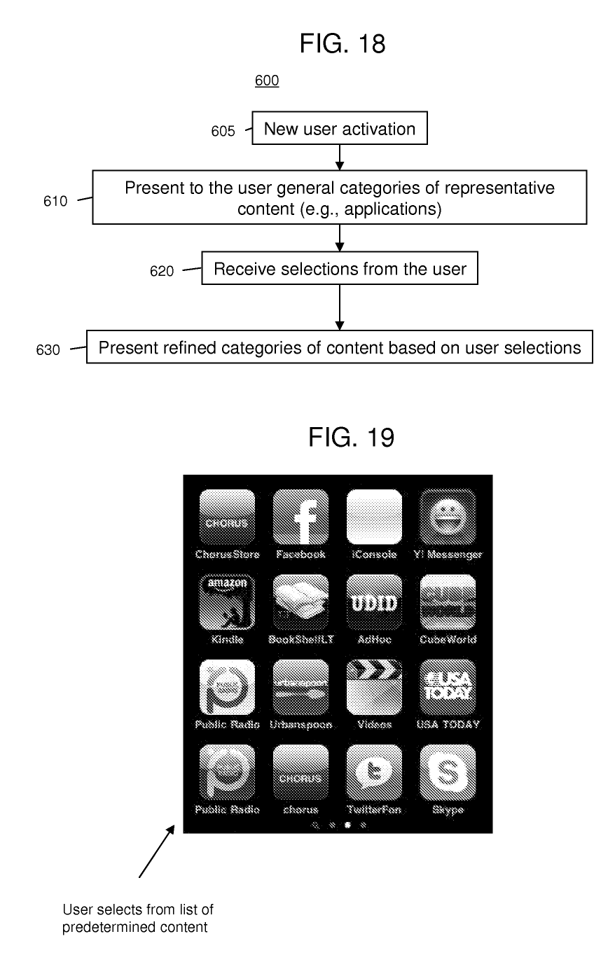

FIG. 18 illustrates a flow chart that depicts a process by which the server 10 quickly learns about a new user to enable him/her to start using the service effectively. A new user is taken through a quick survey to allow the server to learn about the types of contents of interest to the user. A new user is activated at 605. At 610, the server 100 presents to the user a screen that lists some general categories representative content, e.g., applications. FIG. 19 illustrates an example of such a screen. The screen may contain a list of some predetermined applications. At 620, the server 100 receives selections made by the user of one or more of the displayed predetermined applications that the user may be interested in. At 630, the server 100 generates a list of more refined categories of content (e.g., applications) based on the selections received at 620. As explained above, the server 100 employs one or more algorithms to recommend relevant content based on user's profile and initial selections made during the process depicted in FIG. 18. In addition, during the initial phases of user activation, a user can then look through their contacts or popular social networks like Facebook, Twitter etc., or search within the Chorus community to add/invite friends, including an ability to locate other Chorus users who are in physical proximity, such as within a predetermined geographical region.

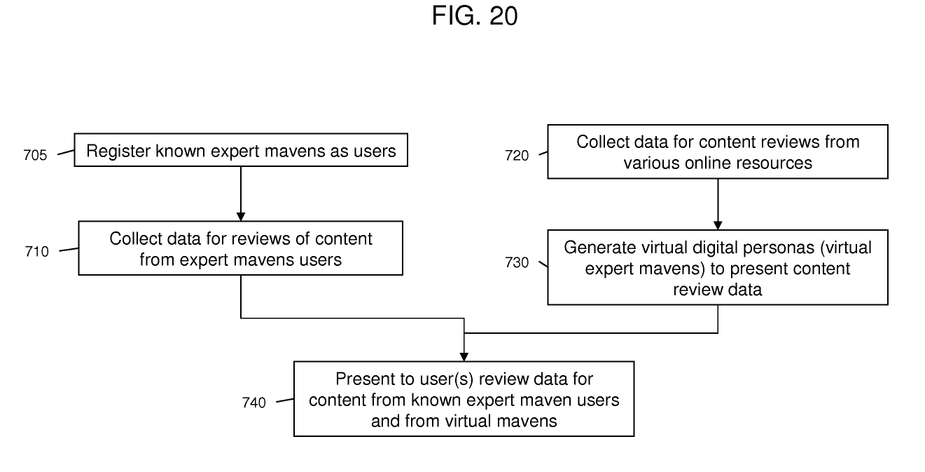

FIG. 20 illustrates a flow chart that depicts a process 700 performed by the server 100 to collect data for content reviews by experts or other sources to build library of content reviews that is helpful to push recommendations for content, especially to new users. At 705, the server 100 identifies known expert “mavens” for certain content, such as applications, music, games, etc., and registers them as users within the service. At 710, the server 100 collects data for content reviews from the expert maven users. At 720, the server 100 collects data for content reviews from various online sources (as indicated at reference numeral 20 in FIG. 1.) At 730, the server generates virtual digital personals based on the reviews collected at 720. These virtual digital personals are fictitious users, or virtual expert mavens, through which the server may present content review data to users. Thus, at 740, the server presents to users review data for content from the known expert mavens collected from the path on the left side of FIG. 20 and for the virtual digital personas generated from the path on the right side of FIG. 20. These reviews are presented to the user when he/she selects the Reviews button in the user interface screen shown in FIG. 15E, for example. In sum, techniques are provided herein to generate targeted content recommendations and/or advertisements for any good or service. At one or more serving computers, data is stored representing social network connections among mobile communication device users. Data related to activity of users in connection with digital content and their connections to each other is collected and monitored. Context-specific trust inferences between connected users are computed based on said monitored/collected data through the analysis techniques described herein. Recommendations for targeted context-based advertisements and/or digital content and information for a particular user for a particular context based on a corresponding context-specific trust inference are generated for the particular user with respect to one or more other users that are connected to the particular user.

Similarly, a computer readable (tangible, non-transitory) memory medium is provided that is encoded with or otherwise stores instructions, that when executed by one or more computing devices (e.g., computers, processors, etc.), causes the one or more computing devices to store data representing social network connections among mobile communication device users; monitor activity of users in connection with digital content and interactions between users; compute context-specific trust inferences between connected users; and generate advertisements to be presented to a particular user for a particular context based on a corresponding context-specific trust inference computed for the particular user with respect to one or more other users that are connected to the particular user.

Further still, an apparatus is provided comprising a network interface device configured to enable communications over a network, and one or more computing devices configured to be coupled to the network interface device, the one or more computing devices configured to: store data representing social network connections among users; monitor activity of users in connection with digital content and interactions between users; compute context-specific trust inferences between connected users; and generate recommendations for digital content and information (including targeted advertisements) for a particular context based on a corresponding context-specific trust inference computed for the particular user with respect to one or more other users that are connected to the particular user.

The above description is intended by way of example only.

What is claimed is:

1. A method comprising:
at one or more serving computers, storing data representing social network connections among mobile communication device users;
monitoring activity of users in connection with digital content and interactions between users;
computing context-specific trust inferences between connected users based on said monitoring; and
generating recommendations for digital content and information for a particular user for a particular context based on a corresponding context-specific trust inference computed for the particular user with respect to one or more other users that are connected to the particular user.

2. The method of claim 1, wherein monitoring comprises tracking data representing web pages viewed by mobile communication device users, and wherein generating recommendations comprises generating advertisements related to the particular context for display to the particular user.

3. The method of claim 1, wherein computing comprises computing a plurality of context-specific trust inferences each for a corresponding context that represents a type of digital content or information.

4. The method of claim 1, and further comprising storing information representing demographic and/or psychographic groups to which users belong, and wherein computing comprises adjusting a context-specific trust inference between connected users depending on which groups the connected users belong.

5. The method of claim 4, wherein adjusting comprises attenuating a context-specific trust inference between two connected users when the two connected users belong to one or more different demographic and/or psychographic groups that is relevant to a corresponding context and boosting a context-specific trust inference between two connected users when the two connected users belong to one or more of the same demographic and/or psychographic groups that is relevant to a corresponding context.

6. The method of claim 1, wherein storing comprises storing data representing social network connections such that a first user may be directly connected to a second user and the first user is indirectly connected to users that are directly connected to the second user, and wherein computing comprises computing context-specific trust inferences between the first user and the second user and as between the first user and other users that are connected to the second user according to a degree of separation limit representing a maximum degree of separate between the first user and any indirectly connected user with respect to the first user.

7. The method of claim 6, and further comprising setting a value of the degree of separation limit for the first user based on a configuration of the one or more server computers.

8. The method of claim 7, and further comprising receiving from the first user a value to be used as the degree of separation limit for context-specific trust inferences computed for the first user.

9. The method of claim 1, wherein generating recommendations comprises generating advertisements related to the particular context for display to the particular user.

10. A method comprising:
at one or more serving computers, storing data representing social network connections among mobile communication device users;
monitoring activity of users in connection with digital content and interactions between users;
computing context-specific trust inferences between connected users from the monitored activity; and
generating advertisements related to a particular context to be presented to a particular user based on a corresponding context-specific trust inference computed for the particular user with respect to one or more other users that are connected to the particular user.

11. The method of claim 10, wherein monitoring comprises tracking data representing web pages viewed by mobile communication device users.

12. The method of claim 10, wherein computing comprises computing a plurality of context-specific trust inferences each for a corresponding context that represents a type of digital content or information.

13. The method of claim 10, and further comprising storing information representing demographic and/or psychographic groups to which users belong, and wherein computing comprises adjusting a context-specific trust inference between connected users depending on which groups the connected users belong.

14. The method of claim 13, wherein adjusting comprises attenuating a context-specific trust inference between two connected users when the two connected users belong to one or more different demographic and/or psychographic groups that is relevant to a corresponding context and boosting a context-specific trust inference between two connected users when the two connected users belong to one or more of the same demographic and/or psychographic groups that is relevant to a corresponding context.

15. A computer readable medium storing instructions, that when executed by one or more computing devices, cause the one or more computing devices to:
store data representing social network connections among mobile communication device users;
monitor activity of users in connection with digital content and interactions between users;
compute context-specific trust inferences between connected users based on the monitored activities of users; and
generate advertisements to be presented to a particular user for a particular context based on a corresponding context-specific trust inference computed for the particular user with respect to one or more other users that are connected to the particular user.

16. The computer readable medium of claim 15, wherein the instructions that cause the processor to monitor comprise instructions that cause the processor to track data representing web pages viewed by mobile communication device users, and wherein the instructions that cause the processor to generate recommendations comprise instructions that cause the processor to generate advertisements for goods or services for the particular context for display to the particular user.

17. The computer readable medium of claim 15, wherein the instructions that cause the processor to compute comprise instructions that cause the processor to compute a plurality of context-specific trust inferences each for a corresponding context that represents a type of digital content or information.

18. The computer readable medium of claim 15, wherein the instructions that cause the processor to monitor comprise instructions that cause the processor to track data representing web pages viewed by mobile communication device users.

19. An apparatus comprising:
a network interface device configured to enable communications over a network;
one or more computing devices configured to be coupled to the network interface device, the one or more computing devices configured to:
store data representing social network connections among users;
monitor activity of users in connection with digital content and interactions between users;
compute context-specific trust inferences between connected users; and
generate recommendations for digital content and information for a particular user for a particular context based on a corresponding context-specific trust inference computed for the particular user with respect to one or more other users that are connected to the particular user.

20. The apparatus of claim 19, wherein the one or more computing devices are configured to generate advertisements related to the particular context for display to the particular user.

21. The apparatus of claim 19, wherein the one or more computing devices are configured to track data representing web pages viewed by mobile communication users.
